(19) United States
(12) Patent Application Publication
(10) Pub. No.: US 2004/0049475 A1
(43) Pub. Date: Mar. 11, 2004

(54) System and method for globally providing document access history information

(75) Inventor: Kazuaki Kidokoro, Shizuoka-ken (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/235,849

(22) Filed: Sep. 6, 2002

(51) Int. Cl. G06F 17/30

(52) U.S. Cl. 707/1

(57) ABSTRACT

A system and method for storing document access history information includes determining a type of access to a first document located on a first document server, and converting a local path address of the first document to a universal path address. First information identifying the type of access to the first document, the universal path address of the first document and an identification of a user who accessed the first document to a document history server is transmitted.

### FIELD OF THE INVENTION

The present invention relates generally to maintaining document access history information, and more particularly to a system and method for providing global access to document access history information and to documents.

### BACKGROUND OF THE INVENTION

With the advent of wide area networks (WANs) and other public networks like the Internet, computer users have become increasingly interconnected. These networks also enable users to have access to a multitude of information and data, even when located at widely disparate locations. In fact, users at opposite ends of the world can have access to the same document, no matter where the document is located.

In general, users have access to documents stored in their own document servers and in public Web servers, as well as in other network storages. The users can access the documents with a variety of devices including personal computers (PCs), personal digital assistants (PDAs), cellular telephones, and hardcopy devices, such as printers, scanners and multi-function peripherals (MFPs). The users can also access the documents from a variety of locations, such as from their office, home, print shop, hotel or any other location providing access to the Internet.

With the variety of users, devices and locations used to access documents located across multiple servers, it can be difficult to keep track of the access activity of the documents. Given this difficulty, it would be desirable to be able to keep track of the access activity for a document and to be able to access the document and its access history regardless of the device used or location of the device.

### SUMMARY OF THE INVENTION

Briefly, in one aspect of the invention, a method for storing document access history information includes determining a type of access to a first document located on a first document server, and converting a local path address of the first document to a universal path address. First information identifying the type of access to the first document, the universal path address of the first document and an identification of a user who accessed the first document to a document history server is transmitted.

### BRIEF DESCRIPTION OF THE DRAWINGS

FIG. 1 is a block diagram of an access history system consistent with the present invention.

FIG. 2 is a flow diagram of a process for generating and storing access history information consistent with the present invention.

FIG. 3 is a flow diagram of a process for generating access history messages consistent with the present information.

FIG. 4 is a flow diagram of a process for retrieving access history information consistent with the present invention

### DETAILED DESCRIPTION OF THE PREFERRED EMBODIMENTS

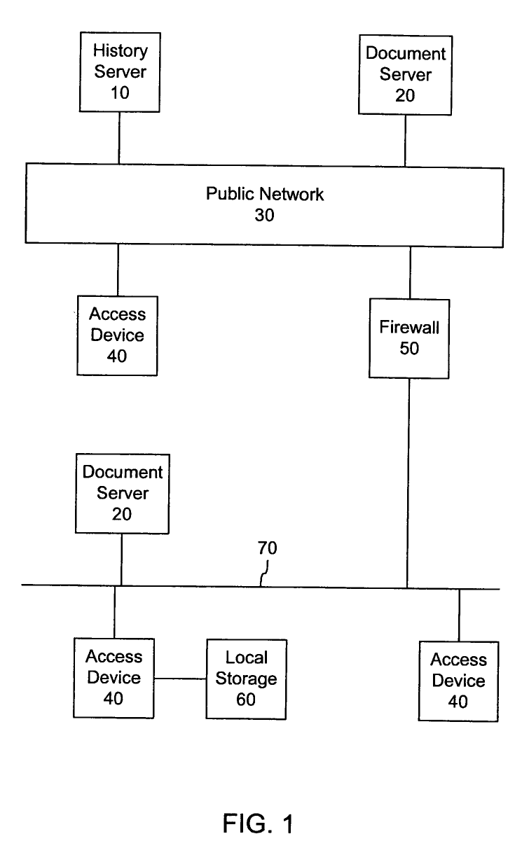

FIG. 1 is a block diagram of an access history system consistent with the present invention. As shown in FIG. 1, the access history system includes at least one history server 10, one or more document servers 20, a public network 30, one or more access devices 40, a firewall 50, a local storage 60 and a local network 70. The history server 10, at least one document server 20 and at least one access device 40 are coupled to the public network 30, which may be implemented as the Internet. The firewall 50 couples the local network 70 to the public network 30. At least one document server 20 and at least one access device 40 are also coupled to the local network 70, which may be a LAN, a Token Ring or other type of local network. The local storage 60 shown in FIG. 1 is coupled to one access device 40, although each access device 40 can have its own dedicated local storage 60. The firewall 50 provides protective and secure communication for devices on the local network 70 when communicating with devices external to the local network 70.

The history server 10 and the document server 20 each include a CPU, a main memory, a ROM, a storage device and a communication interface all coupled together via a bus in one embodiment consistent with the present invention. The CPU may be implemented as a single microprocessor or as multiple processors for a multi-processing system. The main memory is preferably implemented with a RAM and a smaller-sized cache. The ROM is a non-volatile storage, and may be implemented, for example, as an EPROM or NVRAM. The storage device can be a hard disk drive or any other type of non-volatile, writable storage.

The communication interface for the history server 10 and the document server 20 provides a two-way data communication coupling via a network link to the public network 30 and/or local network 70. For example, if the communication interface is an integrated services digital network (ISDN) card or a modem, the communication interface provides a data communication connection to the corresponding type of telephone line. If the communication interface is a local area network (LAN) card, the communication interface provides a data communication connection to a compatible LAN. Wireless links are also possible. In any such implementation, the communication interface sends and receives electrical, electromagnetic or optical signals, which carry digital data streams representing different types of information, to and from the public network 30 and local network 70.

Like the history server 10 and the document server 20, the access device 40 can have a CPU, a main memory, a ROM, a storage device and a communication interface all coupled together via a bus. The access device 40 may also have a communication interface to provide a two-way data communication coupling via a network link to the public network 30 and or local network 70. The network link enables the access device 40 to receive data from and to output data to the history server 10 and document server 20. Instead of a network link, the access device may use a Universal Serial Bus (USB) to connect to a USB port on the history server 10 or document server 20.

In operation, the history server 10, document server 20 and access device 40 all communicate with each other via the public network 30 or via a more direct connection, such as the USB. This communication enables these devices to perform requested functions or provide desired data or information.

The access device 40 can be, for example, a personal computer (PCs), a personal digital assistant (PDA), a cellular telephone, or a hardcopy device, such as a printer, a scanner or a multi-function peripheral (MFP). A user can use an access device to access documents in the document server 20 or access history information in the history server 10 regardless of the location of the access device 40, the location of the document server 20 or the history server 10. For example, a user may have a desktop PC as an access device 40 at the user's office, which the user can use to access documents at the document server 20 coupled to the local network 70 or the document server coupled to the public network 30, or to retrieve access history information from the history server 10. The same user may have a PDA as another access device 40 that the user can use at a hotel on business to retrieve access history information from the history server 10 coupled to the public network 30.

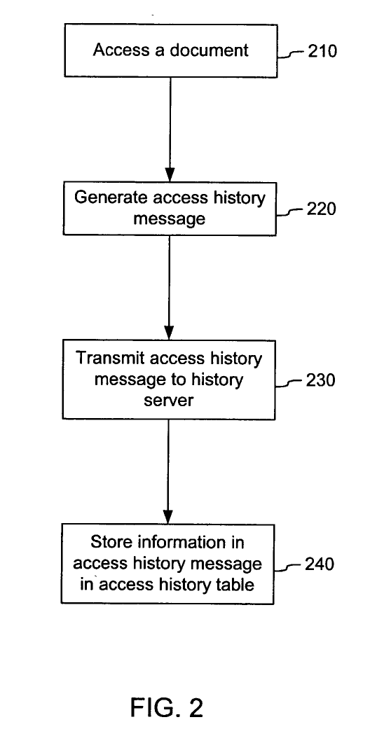

FIG. 2 is a flow diagram of a process for generating and storing access history information consistent with the present invention. As shown in FIG. 2, a user first accesses a document (step 210). The user can access the document with an access device 40, such as a PC. The document being accessed can be located in a document server 20 or in a local storage 60. For example, if the user is operating an access device 40 coupled to the local network 70, the user can access documents in the local storage 60 coupled to the access device 40, access documents in the document server 20 coupled to the local network 70 or access documents in any document server 20 coupled to the public network 30 via the firewall 50. There are also a variety of types of document accesses that the user can perform. These access types include, for example, opening a document, reading a document, printing a document, and saving a document, as well as other access types as are known in the art.

In response to the accessing of the document, an access history message is generated (step 220). The access history message can be generated by the access device 40 that is making the access. Alternatively, the device storing the document, such as the document server 20 or the local storage 60, can generate the access history message. It is also possible for another device configured to monitor document accesses to recognize that a document is being accessed and to correspondingly generate the access history message. To generate the access history message, the device can have software configured to generate the access history message, such as with a software plug-in.

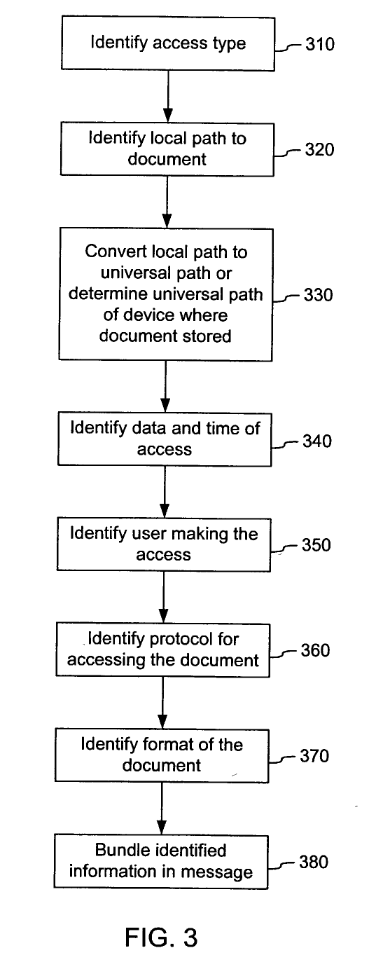

The access history message includes information related to the access of the document by the user. FIG. 3 is a flow diagram of a process for generating access history messages consistent with the present information. As shown in FIG. 3, the access type is identified (step 310). As described above, the type of access of the document can be, for example, to open, to read, to print, to close or to save. In addition to identifying the access type, the local path to the document is identified (step 320). The local path can be an address of a document within the local storage 60 or within the document server 20 in the local network 70. For example, a document in the local storage 60 may have a local path: c:/temp/test.doc. In this address, the ‘c:’ identifies the device storing the document (‘c:’ typically representing a local storage), the ‘temp’ identifies a directory in which the document is located, and the ‘test.doc’ identifies the name of the document.

The local path is then converted to a universal path, or a universal path of the device where the document is stored is identified (step 330). The universal path can be, for example, a uniform resource locator (URL) or any other type of unique address that enables the device storing the document to be located. To convert the local path to the universal path, the part of the local path identifying the device storing the document is converted to the universal path of the device storing the document. For example, if the document server 20 is represented in the local path as ‘h:’ for the document with local path ‘h:/temp/test.doc’, and its universal path is ‘42.112.75’, the conversion would replace the ‘h:’ with the ‘42.112.75’. If the conversion is not done, the universal path for the device storing the document is identified.

The data and time of the access of the document is also identified (step 340). The date and time can be detected from the device storing the document or detected from the access device 40 accessing the document. Furthermore, the identity of the user making the access is identified (step 350). When using the access device 40, the user typically must login to the access device, which indicates to the access device 40 the identity of the user using the access device 40. When making access to the document, the access device 40 can communicate the identity of the user accessing the document to the device that is generating the access history message.

The protocol for accessing the document can also be identified (step 360). The protocol for accessing the document can be, for example, HTTP, FTP, CIFS (a protocol provided by Microsoft Corporation for sharing documents across the network) or any other type of network transfer protocol for transferring data and documents in particular. The protocol can be identified by the manner in which the user accessed the document. For example, the protocol may be HTTP if the access device 40 is accessing a document over the public network 30, and the protocol may be CIFS if the access device 40 is accessing a document over the local network 70. In addition to identifying the protocol, the format of the document can be identified (step 370). The document can be formatted, for example, in an HTML format, an XML format a word processing document format, an image format, such as jpeg or raster image, or any other type of format in which a document may be stored.

All of the identified information is then bundled together as an access history message (step 380). It is not necessary for all of the identified information to be included in the access history message. Moreover, other information in addition to the identified information described above may be included in the access history message, such as time duration, the destination if the access type is sent, the application used to access the document, a title or keyword for the document, as well as any other information that may be useful in identifying or describing the document. The access history message may be formatted as a packet that includes a header identifying what each piece of data in the packet represents. Alternatively, the access history message can be formatted in some other message format or as a document.

Returning to FIG. 2, after the access history message is generated, it is transmitted to the history server 10 (step 230). The access history message can be transmitted using any available network data transfer protocol, such as HTTP or FTP. Alternatively, the access history message can be transmitted by e-mail to the history server 10. The device transmitting the access history message is preferably the device which generates the message, although a separate device for transmitting the message may also be used.

The transmitted access history message is received by the history server 10 and stored in an access history table (step 240). The access history table stores the access history information of any document accessed in any of the document servers 20 or local storages 60. The table itself may be a single table that stores the access history for every document. Alternatively, each document may have its own access history table. It is also possible for the table to be organized according to the location of the document, such as a separate access history table for each document server 20 and local storage 60. The structure of the table may be in a spreadsheet format. It is also possible for the table to be structured as a relational database to facilitate searching for particular types of information based on query data. The tables can be stored in a storage location associated with the history server 10 or distributed across a series of storage locations that are accessible to the history server 10.

According to the processes described above with respect to FIG. 3, data relevant to the access of a document located anywhere on the public network 30 or local network 70 is placed in an access history message and transmitted to the history server 10. The history server 10 then stores the information in the received access history message in one or more access history tables. The information stored in the access history tables can then be retrieved by an access device 40 for a variety of purposes, such as to view the access history of a document, to determine the location of a document or to access a document.

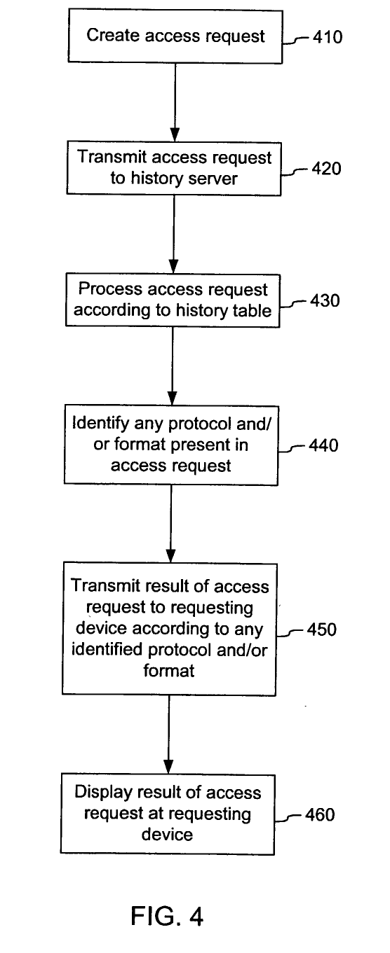

FIG. 4 is a flow diagram of a process for retrieving access history information consistent with the present invention. As shown in FIG. 4, a user creates an access request (step 410). The user can make the access request from any type of access device 40 and from any location. For example, the user can make the access request from the user's PC located at the user's office or from the user's PDA while travelling on business. To create the access request, the access device 40 can have a user interface, such as a GUI, through which the user identifies the type of information that the user wants. The user interface can be a plug-in application loaded into the access device 40. Alternatively, the access request can be requested through a web page that the user accesses from the access device 40. The web page can have a similar interface environment as the plug-in application. In addition, the web page can have security protocols that limit access to the history server to only registered users, such as requiring usernames and passwords.

There is a variety of information that can be requested in the access request. For example, the user can request access history information, such as a list of documents that have been accessed by the user, a list of document that have been accessed at a particular document server 20 in a certain time period or a complete access history of a particular document. The user can also request information identifying the location of a document, such as in which document server 20 the document is stored. Furthermore, the user can request access to a particular document.

In addition to the type of information requested by the user, the access request can include other related information. This other information includes information identifying the user making the request, as well as the location of the access device 40 through which the user is making the request. The access request can also identify a preferred protocol for transmitting the requested information to the access device 40. For example, if the access device 40 is a PDA, the preferred protocol may be a simplified version of HTTP. Similarly, the access request can identify a preferred format. The preferred format may be, for example, an HTML format, an XML format, a word processing document format, an image format, such as jpeg or raster image, or any other type of format in which information may be viewed.

The access request is transmitted to the history server 10 (step 420). Like the access history message, the access request can be transmitted using any available network data transfer protocol, such as HTTP or FTP. Alternatively, the access request can be transmitted by e-mail to the history server 10. If the user generated the access request through a web page, it may be unnecessary to transmit the access request, such as if the web page is supported by the history server 10 itself.

The access request received by the history server 10 is then processed in accordance with the information in the access history table and the information requested in the access request (step 430). The history server 10 is configured to analyze the access request received from the access device 40 and determine what information is being requested. As described above, the access request can request a variety of information or actions, such as access history information, information identifying the location of a document, and access to a particular document.

After determining what information is being requested, the history server 10 refers to the one or more access history tables to retrieve the applicable information. For example, if the access request seeks the access history for a particular document, the history server 10 would search the one or more access history tables and identify the access history for the document identified in the access request. In another example, if the access request seeks retrieval of a particular document, the history server 10 searches the one or more access history tables to identify the universal path to the document requested in the access request.

In addition to retrieving the information requested in the access request, the history server 10 identifies any preferred protocol or preferred format present in the access request (step 440). As described above, the access request can identify a preferred protocol for transmitting the requested information to the access device 40, such as HTTP or FTP, as well as a preferred format, such as HTML. Using this information, the history server can provide the results of the information requested in the access request to the access device 40 in the format identified in the access request and transmit the information using the protocol identified in the access request.

To provide the information in the format identified in the access request, the history server 10 can convert the information into the identified format. This conversion may be needed if the information in the access history tables is stored in a format different from the format identified in the access request. For example, if the information in the access history tables is stored in an XML database, and the access request identifies the preferred format as HTML, then the history server 10 can convert the requested information from an XML format to and HTML format.

Furthermore, if the information requested in the access request is the document itself, the history server 10 can retrieve the document from its location determined from the search of the one or more access history tables. The history server 10 can then create a new instance of the document as a temporary file in a buffer area of its storage in the format identified in the access request. For example, if the requested format is HTML, and the document is in a word processing format, then the history server 10 can convert the document from the word processing format to the HTML format, and store the converted document as a temporary file in the buffer, which is then used for the transmission to the access device 40.

After providing the requested information in the format identified in the access request, the information is transmitted to the access device 40 (step 450). If no format is identified in the access request, then the requested information can be provided in a default format or whatever format the information is stored in the history server 10. In addition, if a protocol is identified in the access request, the requested information is transmitted to the access device 40 using the identified protocol. Otherwise, a default protocol, such as HTTP, can be used to transmit the requested information to the access device 40. In addition to the protocols identified above, it is possible for the requested information to be transmitted to the access device 40 by e-mail.

The requested information transmitted to the access device 40 can then be displayed to the user (step 460). The manner in which the requested information is viewed can depend on the manner in which the access device 40 accesses the history server 10, as well as the application used by the access device to view the requested information. For example, if the access device 40 accesses the history server 10 with a plug-in application, the requested information can be received by the plug-in application, which is configured to display the requested information to the user. Alternatively, if the access device 40 accesses the history server 10 via a web page, the web server supporting the web page, which can be the history server 10 itself, can be configured to display the requested information to the user. In another alternative, the requested information can be stored in the access device 40 as a document, which the user selects or clicks on to open and view the requested information. For example, the requested information can be stored as an image file, such as a raster image, which the user selects with a document management application like Windows Explorer (a product of Microsoft Corporation). The selected document can then be opened and viewed with an application capable of displaying raster images, such as Microsoft Photo Editor (a product of Microsoft Corporation).

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method for processing document access history information, comprising:
determining a type of access to a first document located on a first document server;
converting a local path address of the first document to a universal path address; and
transmitting first information identifying the type of access to the first document, the universal path address of the first document and an identification of a user who accessed the first document to a document history server.

2. A method according to claim 1, further comprising:
determining a type of access to a second document located on a second document server different from the first document server;
converting a local path address of the second document to a universal path address; and
transmitting second information identifying the type of access to the second document, the universal path address of the second document and an identification of a user who accessed the second document to the document history server.

3. A method according to claim 2, further comprising storing the first and second information in a table stored in a storage area of the document history server.

4. A method according to claim 3, further comprising organizing the first and second information in the table according to the universal path address.

5. A method according to claim 3, further comprising organizing the first and second information in the table according to the identification of the user.

6. A method according to claim 2, wherein the first information further includes information identifying a protocol used by the user to access the first document, and the second information includes information identifying a protocol used by the user to accdess the second document.

7. A method according to claim 2, wherein the first document server, the second document server and the document history server are separate and independent computers.

8. A method according to claim 7, wherein the first document server, the second document server and the document history server are located at different locations.

9. A method according to claim 2, further comprising:
transmitting a request for information to the document history server; and
receiving a response from the document history server based on the information stored in the table in the document history server in accordance with the request.

10. A method according to claim 8, wherein the request for information includes one of a request for a list of documents accessed by a particular user, a request for a list of documents accessed at one of the first and second document servers in a particular time period, and a request for an access history of one of the first and second documents.

11. A method according to claim 8, wherein the request includes information identifying the type of information desired from the table, a location to which to transmit the requested information, a protocol for transmitting the requested information, and a format for the requested information.

12. A method according to claim 3, further comprising:
transmitting a request for a document to the document history server; and
receiving the requested document from the document history server based on the information stored in the table in the document history server in accordance with the request.

13. A method according to claim 12, wherein the request includes information identifying a supported format for viewing the document, and the requested document received from the document history server is received in the format identified in the request.

14. A method for processing document access history information, comprising:
receiving first information identifying a type of access to a first document located on a first document server, a local path address of the first document, a universal path address of the first document server and an identification of a user who accessed the first document; and
storing the received first information in a table in a storage area of a document history server.

15. A method according to claim 14, further comprising:
receiving second information identifying a type of access to a second document located on a second document server different from the first document server, a local path address of the second document, a universal path address of the second document server and an identification of a user who accessed the second document; and
storing the received second information in the table in the storage area of the document history server.

16. A method according to claim 15, further comprising organizing the first and second information in the table according to the universal path address.

17. A method according to claim 15, further comprising organizing the first and second information in the table according to the identification of the user.

18. A method according to claim 15, wherein the first information further includes information identifying a protocol used by the user to access the first document, and the second information includes information identifying a protocol used by the user to access the second document.

19. A method according to claim 15, wherein the first document server, the second document server and the document history server are separate and independent computers.

20. A method according to claim 19, wherein the first document server, the second document server and the document history server are located at different locations.

21. A method according to claim 15, further comprising:
receiving a request for information at the document history server; and
transmitting a response from the document history server based on the information stored in the table in the document history server in accordance with the request.

22. A method according to claim 21, wherein the request for information includes one of a request for a list of documents accessed by a particular user, a request for a list of documents accessed at one of the first and second document servers in a particular time period, and a request for an access history of one of the first and second documents.

23. A method according to claim 21, wherein the request includes information identifying the type of information desired from the table, a location to which to transmit the requested information, a protocol for transmitting the requested information, and a format for the requested information.

24. A method according to claim 15, further comprising:
receiving a request for a document at the document history server; and
transmitting the requested document from the document history server based on the information stored in the table in the document history server in accordance with the request.

25. A method according to claim 24, wherein the request includes information identifying a supported format for viewing the document, and the requested document transmitted from the document history server is transmitted in the format identified in the request.

26. A computer system for processing document access history information, comprising:
a processor; and
a memory, coupled to the processor, which stores a plurality of instructions executed by the processor, the plurality of instructions configured to:
determine a type of access to a first document located on a first document server;
convert a local path address of the first document to a universal path address; and
transmit first information identifying the type of access to the first document, the universal path address of the first document and an identification of a user who accessed the first document to a document history server.

27. A computer system according to claim 26, the memory further comprising instructions configured to:
determine a type of access to a second document located on a second document server different from the first document server;
convert a local path address of the second document to a universal path address; and
transmit second information identifying the type of access to the second document, the universal path address of the second document and an identification of a user who accessed the second document to the document history server.

28. A computer system according to claim 27, wherein the first and second information are stored in a table stored in a storage area of the document history server.

29. A computer system according to claim 28, wherein the first information further includes information identifying a protocol used by the user to access the first document, and the second information includes information identifying a protocol used by the user to access the second document.

30. A computer system according to claim 28, wherein the first document server, the second document server and the document history server are separate and independent computers.

31. A computer system according to claim 28, the memory further comprising instructions configured to:
transmit a request for information to the document history server; and
receive a response from the document history server based on the information stored in the table in the document history server in accordance with the request.

32. A computer system according to claim 31, wherein the request for information includes one of a request for a list of documents accessed by a particular user, a request for a list of documents accessed at one of the first and second document servers in a particular time period, and a request for an access history of one of the first and second documents.

33. A computer system according to claim 31, wherein the request includes information identifying the type of information desired from the table, a location to which to transmit the requested information, a protocol for transmitting the requested information, and a format for the requested information.

34. A computer system according to claim 28, the memory further comprising instructions configured to:
transmit a request for a document to the document history server; and
receive the requested document from the document history server based on the information stored in the table in the document history server in accordance with the request.

35. A computer system according to claim 34, wherein the request includes information identifying a supported format for viewing the document, and the requested document received from the document history server is received in the format identified in the request.

36. A computer system for processing document access history information, comprising:
a processor; and
a memory, coupled to the processor, which stores a plurality of instructions executed by the processor, the plurality of instructions configured to:
receive first information identifying a type of access to a first document located on a first document server, a local path address of the first document, a universal path address of the first document server and an identification of a user who accessed the first document; and
store the received first information in a table in a storage area of the computer system.

37. A computer system according to claim 36, the memory further comprising instructions configured to:
receive second information identifying a type of access to a second document located on a second document server different from the first document server, a local path address of the second document, a universal path address of the second document server and an identification of a user who accessed the second document; and
store the received second information in the table in the storage area of the computer system.

38. A computer system according to claim 37, the memory further comprising an instruction configured to organize the first and second information in the table according to the universal path address.

39. A computer system according to claim 37, the memory further comprising an instruction configured to organize the first and second information in the table according to the identification of the user.

40. A computer system according to claim 37, wherein the first information further includes information identifying a protocol used by the user to access the first document, and the second information includes information identifying a protocol used by the user to access the second document.

41. A computer system according to claim 37, the memory further comprising instructions configured to:
receive a request for information; and
transmit a response based on the information stored in the table in accordance with the request.

42. A computer system according to claim 41, wherein the request for information includes one of a request for a list of documents accessed by a particular user, a request for a list of documents accessed at one of the first and second document servers in a particular time period, and a request for an access history of one of the first and second documents.

43. A computer system according to claim 41, wherein the request includes information identifying the type of information desired from the table, a location to which to transmit the requested information, a protocol for transmitting the requested information, and a format for the requested information.

44. A computer system according to claim 37, the memory further comprising instructions configured to:
receive a request for a document; and
transmit the requested document based on the information stored in the table in accordance with the request.

45. A computer system according to claim 44, wherein the request includes information identifying a supported format for viewing the document, and the requested document is transmitted in the format identified in the request.

46. A computer readable medium operable on a computer system configured to process document access history information, the computer readable medium configured to:
determine a type of access to a first document located on a first document server;
convert a local path address of the first document to a universal path address; and
transmit first information identifying the type of access to the first document, the universal path address of the first document and an identification of a user who accessed the first document to a document history server.

47. A computer readable medium according to claim 46, further configured to:
determine a type of access to a second document located on a second document server different from the first document server;
convert a local path address of the second document to a universal path address; and
transmit second information identifying the type of access to the second document, the universal path address of the second document and an identification of a user who accessed the second document to the document history server.

48. A computer readable medium according to claim 47, wherein the first and second information are stored in a table stored in a storage area of the document history server.

49. A computer readable medium according to claim 47, wherein the first information further includes information identifying a protocol used by the user to access the first document, and the second information includes information identifying a protocol used by the user to access the second document.

50. A computer readable medium according to claim 47, wherein the first document server, the second document server and the document history server are separate and independent computers.

51. A computer readable medium according to claim 48, further configured to:
transmit a request for information to the document history server; and
receive a response from the document history server based on the information stored in the table in the document history server in accordance with the request.

52. A computer readable medium according to claim 51, wherein the request for information includes one of a request for a list of documents accessed by a particular user, a request for a list of documents accessed at one of the first and second document servers in a particular time period, and a request for an access history of one of the first and second documents.

53. A computer readable medium according to claim 51, wherein the request includes information identifying the type of information desired from the table, a location to which to transmit the requested information, a protocol for transmitting the requested information, and a format for the requested information.

54. A computer readable medium according to claim 48, further configured to:
transmit a request for a document to the document history server; and
receive the requested document from the document history server based on the information stored in the table in the document history server in accordance with the request.

55. A computer readable medium according to claim 54, wherein the request includes information identifying a supported format for viewing the document, and the requested document received from the document history server is received in the format identified in the request.

56. A computer readable medium operable on a computer system configured to process document access history information, the computer readable medium configured to:
receive first information identifying a type of access to a first document located on a first document server, a local path address of the first document, a universal path address of the first document server and an identification of a user who accessed the first document; and
store the received first information in a table in a storage area of the computer system.

57. A computer readable medium according to claim 56, further configured to:
receive second information identifying a type of access to a second document located on a second document server different from the first document server, a local path address of the second document, a universal path address of the second document server and an identification of a user who accessed the second document; and
store the received second information in a table in a storage area of the computer system.

58. A computer readable medium according to claim 57, further configured to organize the first and second information in the table according to the universal path address.

59. A computer readable medium according to claim 57, further configured to organize the first and second information in the table according to the identification of the user.

60. A computer readable medium according to claim 57, wherein the first information further includes information identifying a protocol used by the user to access the first document, and the second information includes information identifying a protocol used by the user to access the second document.

61. A computer readable medium according to claim 57, further configured to:
receive a request for information at the document history server; and
transmit a response from the document history server based on the information stored in the table in the document history server in accordance with the request.

62. A computer readable medium according to claim 61, wherein the request for information includes one of a request for a list of documents accessed by a particular user, a request for a list of documents accessed at one of the first and second document servers in a particular time period, and a request for an access history of one of the first and second documents.

63. A computer readable medium according to claim 61, wherein the request includes information identifying the type of information desired from the table, a location to which to transmit the requested information, a protocol for transmitting the requested information, and a format for the requested information.

64. A computer readable medium according to claim 57, further configured to:
receive a request for a document at the document history server; and
transmit the requested document from the document history server based on the information stored in the table in the document history server in accordance with the request.

65. A computer readable medium according to claim 64, wherein the request includes information identifying a supported format for viewing the document, and the requested document transmitted from the document history server is transmitted in the format identified in the request.
